(19) United States
(12) Patent Application Publication
(10) Pub. No.: US 2011/0179366 A1
(43) Pub. Date: Jul. 21, 2011

(54) METHOD AND APPARATUS FOR PRIVACY PROTECTION IN MOBILE TERMINAL

(75) Inventor: Hyi Hong CHAE, Suwon-si (KR)

(73) Assignee: SAMSUNG ELECTRONICS CO. LTD., Suwon-si (KR)

(21) Appl. No.: 13/008,139

(22) Filed: Jan. 18, 2011

(30) Foreign Application Priority Data
Jan. 18, 2010 (KR) 10-2010-0004317

(51) Int. Cl. G06F 3/048

(52) U.S. Cl. 715/764

(57) ABSTRACT

A method and an apparatus for privacy protection in a mobile terminal are provided. Upon detection of a user interaction through a detecting module during use, screen data containing private information can be temporarily hidden. The method includes displaying screen data of an application in execution on a display unit, recognizing a user interaction to hide the displayed screen data of the application, hiding the screen data of the application from the display unit upon recognition of the user interaction.

### PRIORITY

This application claims the benefit under 35 U.S.C. §119(a) of a Korean patent application filed on Jan. 18, 2010 in the Korean Intellectual Property Office and assigned Serial No. 10-2010-0004317, the entire disclosure of which is hereby incorporated by reference.

### BACKGROUND OF THE INVENTION

1. Field of the Invention

The present invention relates to a mobile terminal. More particularly, the present invention relates to a method and an apparatus for privacy protection in a mobile terminal that hides displayed screen data or locks the terminal in response to a preset user interaction during execution of an application function to protect privacy of the user.

2. Description of the Related Art

Advances in digital technology have led to the popularity of various mobile terminals, such as mobile communication terminals, personal digital assistants and smart phones, which enable users to communicate and process information while mobile. Such mobile terminals provide various supplementary functions related to schedule management, memo writing, phonebook management, message transmission and image capture for user convenience.

Hence, a mobile terminal may store various kinds of private information of the user, such as call logs (e.g., list of incoming calls, list of outgoing calls, list of missed calls, list of outgoing messages, and list of incoming messages), schedules, photographs, and sent and received messages.

In the above described system, the user may utilize various supplementary functions provided by the mobile terminal. For example, the user may utilize the mobile terminal to read a received message, compose a message to be sent, write a memo, view a stored photograph, view a schedule, view the call log, and view a moving image. Screen data displayed on the screen during use of such a supplementary function may be private information that the user does not wish to disclose to others. For example, while reading a received message or composing a message, the user may not wish the screen data to be viewed by others.

To protect screen data as private information from others, the user may enter a ‘hold’ key or an ‘end’ key. However, entering the ‘hold’ key or the ‘end’ key requires precise key manipulation, making it difficult to rapidly hide the screen data in an unexpected situation. In addition, to temporarily hide the screen data while preserving the screen data, the user may have to enter the ‘hold’ key for a preset time (e.g., long key press). This press for the preset time and subsequent screen transition takes time, and hence may result in a breach of privacy.

Furthermore, entering the ‘end’ key may cause the current screen data to be lost. For example, when the user enters the ‘end’ key during message composition or message reading, the message handling function is terminated, the message screen data disappears, and the idle screen may be displayed. Later, the user may be inconvenienced by having to compose a new message from scratch or to navigate the menu hierarchy to locate the received message. As another example, when the user enters the ‘end’ key while viewing a moving image, the moving image screen disappears and the idle screen may be displayed. Later, the user may be inconvenienced by having to repeat a procedure for viewing the moving image from the beginning

Therefore, a need exists for a method and an apparatus for privacy protection that can temporarily hide private information and lock the mobile terminal while preserving the current execution mode in response to a user interaction during use.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for privacy protection that can effectively hide private information and lock the mobile terminal during use.

Another aspect of the present invention is to provide a method and an apparatus for privacy protection that can temporarily hide private information and lock the mobile terminal while preserving the current execution mode in response to a user interaction to hide the displayed private information during use.

Still another aspect of the present invention is to provide a method and an apparatus for privacy protection in a mobile terminal that can activate, upon detection of a user interaction to hide the displayed private information during execution of a function, a hiding mode to hide screen data related to the function, and activate a locking mode when a user interaction for deactivating the hiding mode is not generated for longer than a preset time.

In accordance with an aspect of the present invention, a method for privacy protection in a mobile terminal is provided. The method includes displaying screen data of an application in execution on a display unit, recognizing a user interaction to hide the displayed screen data of an application, hiding the screen data of the application from the display unit upon recognition of user interaction.

In accordance with another aspect of the present invention, a mobile terminal is provided. The mobile terminal includes a display unit for displaying screen data of an application being executed, and for being turned off or replacing the screen data of the application with screen data of a screensaver upon activation of a hiding mode, a storage unit for storing option information that processes the hiding mode and for storing threshold time information that activates a locking mode after hiding the mode activation, a detecting module for detecting user interaction and for producing corresponding interaction information, and a control unit for controlling the display unit to hide screen data of the application in response to reception of interaction information from the detecting module during execution of the application.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 and 2 illustrate an external appearance of a mobile terminal according to an exemplary embodiment of the present invention;

FIG. 3 is a block diagram of a mobile terminal according to an exemplary embodiment of the present invention;

FIG. 4 is a flowchart of a method for privacy protection in a mobile terminal according to an exemplary embodiment of the present invention; and

FIG. 5 is a flowchart of a privacy protection method according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention relate to a method and an apparatus for privacy protection in a mobile terminal. For effective privacy protection, the currently executed function and related screen data can be hidden in response to a user interaction occurring near the mobile terminal during use. To address this issue, the mobile terminal includes a detecting module for detecting user interactions and a control unit for operating the detecting module. The detecting module may include a proximity sensor, an ambient light sensor and a camera module. In an exemplary implementation, the detecting module may include all of a proximity sensor, an ambient light sensor and a camera module. In an exemplary implementation, the detecting module may include one or more of a proximity sensor, an ambient light sensor and a camera module.

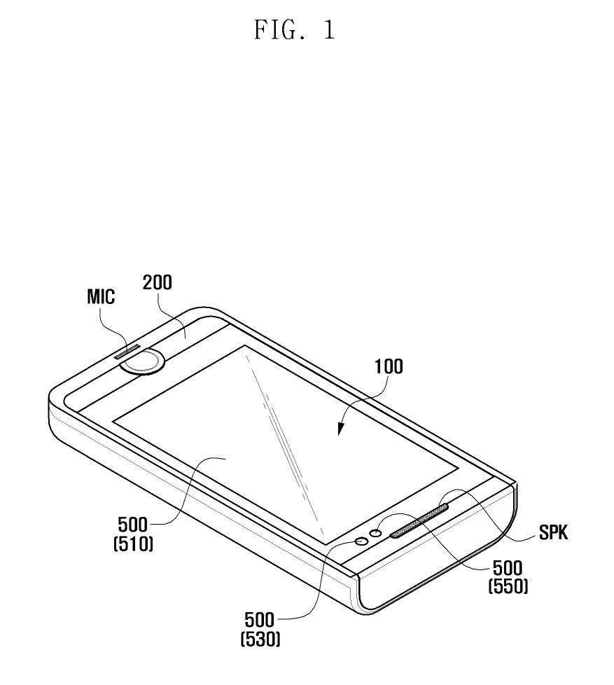

Hereinafter, a description is given of the external appearance and configuration of the mobile terminal in connection with FIGS. 1 to 3. However, exemplary embodiments of the present invention are not limited to or by the following description, and various changes and modifications are possible based on the following description.

FIGS. 1 to 5, discussed herein, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

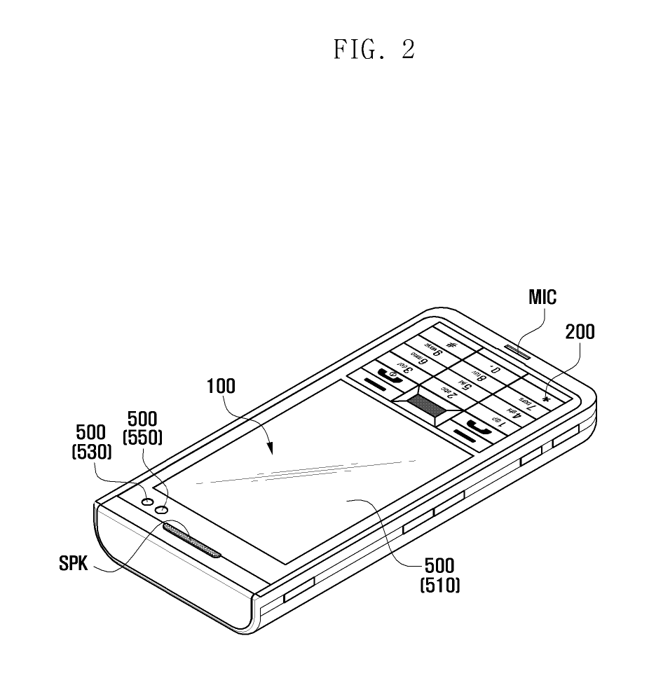

FIGS. 1 and 2 illustrate an external appearance of a mobile terminal according to an exemplary embodiment of the present invention.

More particularly, FIG. 1 depicts a bar type mobile terminal having a full touch screen feature, and FIG. 2 depicts a bar type mobile terminal having a separate display and an input means.

Referring to FIGS. 1 and 2, the mobile terminal may include a display means 100 for displaying various screen data related to functions of the mobile terminal, an input means 200 for generating an input signal according to a user action, a speaker (SPK) for producing various audio signals related to functions of the mobile terminal, a microphone (MIC) for receiving an audio signal such as a voice signal from the outside, and a detecting module 500 for recognizing a user interaction.

In an exemplary embodiment of the present invention, the detecting module 500 may include any detecting means that can track the user interaction and produce a corresponding interaction result. For example, the detecting module 500 may include a proximity sensor 510 that detects the user interaction occurring near the mobile terminal and produces a corresponding interaction result, a camera module 530 that captures an image of the user during a video call, takes a photograph of a target object in a photography mode, and detects user interaction occurring within the range of the camera module 530 and produces a corresponding interaction result in an interaction detecting mode, and an ambient light sensor 550 that detects the user interaction occurring near the mobile terminal and produces a corresponding interaction result.

The location at which the detecting module 500 is placed is not necessarily limited by FIG. 1 or 2, and may be changed according to the type of the mobile terminal. In FIG. 1 or 2, the mobile terminal is described as including the proximity sensor 510, the camera module 530, and the ambient light sensor 550. However, the mobile terminal is not necessarily limited to such a configuration.

In an exemplary implementation, the detecting module 500 may include only one of the proximity sensor 510, the camera module 530, and the ambient light sensor 550. For example, the detecting module 500 may include only the proximity sensor 510, and the camera module 530 and the ambient light sensor 550 may be excluded from FIGS. 1 and 2. The structure of the detecting module 500 may be changed according to the type of the mobile terminal.

In an exemplary implementation, the detecting module 500 may include a combination of the proximity sensor 510, the camera module 530, and the ambient light sensor 550. For example, the detecting module 500 may include one of the proximity sensor 510 and the ambient light sensor 550, the proximity sensor 510 and the camera module 530, the camera module 530 and the ambient light sensor 550, and the proximity sensor 510, the camera module 530 and the ambient light sensor 550. The elements constituting the detecting module 500 may be placed at locations suitable for detecting the user interaction.

In an exemplary implementation, the mobile terminal may include a plurality of proximity sensors 510, a plurality of camera modules 530, and a plurality of ambient light sensors 550. For example, four proximity sensors 510 may be installed near the top, bottom, left and right borders of the front side of the mobile terminal in FIG. 1 or 2. Four ambient light sensors 550 may be installed near the top, bottom, left and right borders of the front side of the mobile terminal in FIG. 1 or 2. As another example, two proximity sensors 510 may be installed near the left and right borders of the front side of the mobile terminal in FIG. 1 or 2, and two ambient light sensors 550 may be installed near the top and bottom borders of the front side.

In the above described system, for rapid detecting of user interaction, the detecting module 500 may be designed to include a plurality of identical or different detecting devices. When the detecting module 500 includes multiple detecting devices, the mobile terminal may perform different control operations according to the forms or locations of the devices recognizing user interaction.

For example, referring to FIG. 1 where the location of the microphone corresponds to the bottom of the front side of the mobile terminal, it may be assumed that a first proximity sensor is installed at the left and a second proximity sensor is installed at the right. When the user interaction is detected by the first proximity sensor at the left, the mobile terminal may activate the hiding mode and perform a first function associated with the first proximity sensor (for example, running a preset screensaver) in the hiding mode. When the user interaction is detected by the second proximity sensor at the right, the mobile terminal may activate the hiding mode and perform a second function associated with the second proximity sensor (for example, turning off the display means 100) in the hiding mode.

As another example, referring to FIG. 1 where the location of the microphone corresponds to the bottom of the front side of the mobile terminal, it may be assumed that the detecting module 500 includes a proximity sensor and an ambient light sensor. When the proximity sensor detects a user interaction, the mobile terminal may activate the hiding mode and perform a first function associated with the proximity sensor (for example, running a preset screensaver) in the hiding mode. When the ambient light sensor detects the user interaction, the mobile terminal may activate the hiding mode and perform a second function associated with the ambient light sensor (for example, turning off the display means 100) in the hiding mode.

Although the mobile terminal shown in FIG. 1 or 2 is a bar type terminal, exemplary embodiments of the present invention are applicable to a mobile terminal of any type such as a folder type terminal, a slide type terminal, or a flip type terminal. The mobile terminal of the present invention may be any information and communication appliance that may perform privacy protection operations based on a detecting module.

For example, the mobile terminal of the present invention may be a mobile communication terminal supporting a communication protocol for a communication system, or a small sized device such as a Portable Multimedia Player (PMP), a digital broadcast receiver, a Personal Digital Assistant (PDA), a music player such as an MP3 player, a portable game console, a smart phone or a tablet Personal Computer (PC). In addition, the method for privacy protection of the present invention may be applied to medium to large sized devices such as a television set, a large format display, a digital signage, a media kiosk, a personal computer, and a laptop computer. Next, a description of the configuration of the mobile terminal is provided.

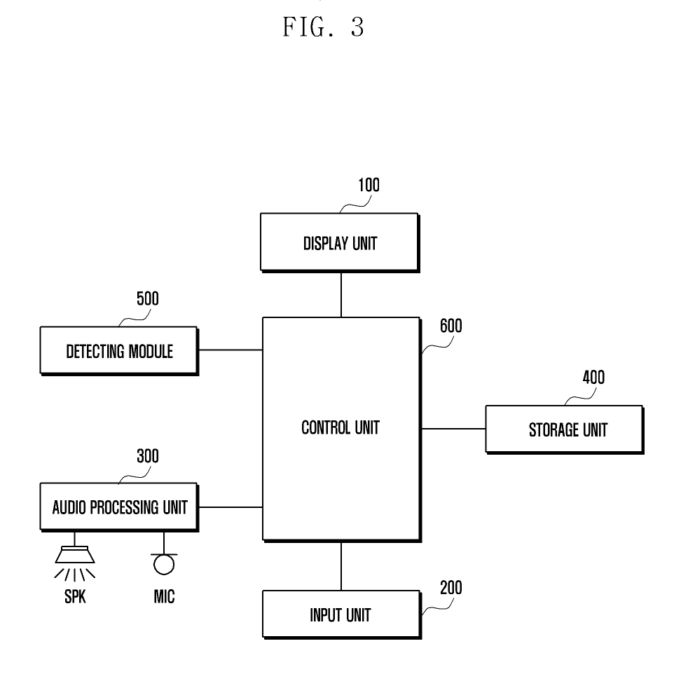

FIG. 3 is a block diagram of a mobile terminal according to an exemplary embodiment of the present invention.

Referring to FIG. 3, the mobile terminal includes an input unit 200, an audio processing unit 300, a display unit 100, a storage unit 400, a detecting module 500, and a control unit 600. The audio processing unit 300 may include a speaker (SPK) and a microphone (MIC). The detecting module 500 may include at least one of a proximity sensor 510, a camera module 530, and an ambient light sensor 550. A description of each component of the mobile terminal is provided below.

The input unit 200 sends input signals for entering various alphanumeric information and for setting and controlling various functions to the control unit 600. That is, the input unit 200 generates input signals carrying commands for controlling the overall operation of the mobile terminal. The input unit 200 includes a plurality of alphanumeric and function keys for generating input signals. The function keys may include direction, side, and shortcut keys associated with corresponding functions (for example, a shortcut key for activating the hiding mode). The input unit 200 may include one or more of a touchpad, a touch screen, a keypad (a QWERTY layout, a 3*4 layout, or a 4*3 layout), and a dome key according to design.

The audio processing unit 300 may include a speaker (SPK) for reproducing an audio signal, and a microphone (MIC) for collecting an audio signal such as a voice signal. The audio processing unit 300 is connected with the microphone MIC and the speaker SPK. The audio processing unit 300 converts a voice signal from the microphone MIC into data and sends the data to the control unit 600, and outputs an audio signal from the control unit 600 through the speaker SPK. The audio processing unit 300 may reproduce various audio signals generated by the mobile terminal (such as an audio signal generated during playback of video data or audio data, and an alarm signal generated by activation of the hiding mode) according to a user selection.

The display unit 100 displays a screen activated according to operation of the mobile terminal. For example, the display unit 100 may display a boot screen, an idle screen, a menu screen, a listing screen, a playback screen, and an application related screen. The display unit 100 may display various screen data related to the operation and the state of the mobile terminal, and visually outputs various signals and color information from the control unit 600. The display unit 100 may be realized using a Liquid Crystal Display (LCD), an Organic Light Emitting Diode (OLED), or an Active Matrix OLED (AMOLED) technology. The display unit 100 may have a touch screen capability. In this case, the display unit 100 may act as an input means and an output means, and the input unit 200 may be removed according to the design of the mobile terminal.

More particularly, when the hiding mode is activated in response to the user interaction, the control unit 600 may turn off the display unit 100. At this time, the screen data being displayed is preserved and the backlight of the display unit 100 may be turned off. Alternatively, when the hiding mode is activated in response to the user interaction, the control unit 600 may place the current function in the background and run a preset screensaver program to obtain screen transition on the display unit 100.

The storage unit 400 stores various data created and used in the mobile terminal. Such data may include data generated in the course of using the mobile terminal, data received from external sources (for example, another mobile terminal, a personal computer, and a web server). Such data may include various types of data such as video, audio, broadcasts, photographs, messages, documents and images. The storage unit 400 may store various applications implementing functions of the mobile terminal. More particularly, the storage unit 400 may store a software program controlling operations in the hiding mode.

The storage unit 400 may store option information necessary for privacy protection in the mobile terminal. The option information may include information on methods of activating the hiding mode, and threshold time information for activating the locking mode after hiding mode activation. The methods of activating the hiding mode may include a screen transition option in which the current screen data is replaced with screen data of a preset screensaver, and a screen-off option in which display of screen data is blocked by turning off the backlight of the display unit 100. The storage unit 400 may store at least one piece of screensaver data. Various forms of data, such as dynamic data and static data provided by the mobile terminal and photographic data provided by the user, may be set as screensaver data according to user settings.

The storage unit 400 may include one or more buffers to temporarily store data generated by function execution of the mobile terminal 100. For example, the storage unit 400 may buffer screen data being displayed at the time of hiding mode activation during execution of the privacy protection function. The storage unit 400 may include internal storage media and external storage media such as a smart card. The storage unit 150 may include any or all of a Read Only Memory (ROM), a Random Access Memory (RAM), a flash memory, and a combination thereof such as a multi-chip package.

The detecting module 500 detects user interaction by means of the finger or another object occurring near the mobile terminal, and sends the detected result to the control unit 600. That is, the detecting module 500 detects user interaction occurring in the space near the mobile terminal while a user-requested function is executed, and creates corresponding interaction information and sends the same to the control unit 600.

The detecting module 500 may be allowed to operate when the mobile terminal is booted or when activated by the user. The detecting module 500 may be allowed to operate only when a given application is executed. That is, the detecting module 500 may be operated in various ways according to user settings for the privacy protection function. As described before in connection with FIGS. 1 and 2, the detecting module 500 may use at least one of the proximity sensor 510, camera module 530, and ambient light sensor 550.

Each of the proximity sensor 510 and the ambient light sensor 550 detects user interaction occurring near the mobile terminal. Each of the proximity sensor 510 and the ambient light sensor 550 tracks movement of a given object or the finger near the mobile terminal during execution of a specific application function, and creates a corresponding result and sends the same to the control unit 600.

The camera module 530 captures an image of a target object under the control of the control unit 600, and sends the captured image to the display unit 100 and the control unit 600. The camera module 530 may include a lens (not shown) receiving light, an image sensor (not shown) converting the light received by the lens into an electrical signal, and a signal processor (not shown) converting the electrical signal from the image sensor into digital data. The image sensor may be a Charge-Coupled Device (CCD) sensor or a Complementary Metal Oxide Semiconductor (CMOS) sensor.

More particularly, the camera module 530 detects user interaction occurring in the space near the mobile terminal. The camera module 530 tracks movement of a given object or the finger during execution of a specific application function, and creates a corresponding result and sends the same to the control unit 600. During execution of the privacy protection function, data produced by the camera module 530 is not displayed on the display unit 100 (for example, previewing is disabled). In other words, data captured by the camera module 530 during execution of the privacy protection function is processed in the background and is used only to recognize user interaction.

In the above description related with FIGS. 1 to 3, user interaction for controlling the privacy protection function is detected based on the proximity sensor 510, the ambient light sensor 550 and the camera module 530. However, the exemplary embodiments of present invention are not necessarily limited thereto or thereby. That is, user interaction for controlling the privacy protection function may be entered or received through a touchpad, touch screen, or microphone. For example, the privacy protection function may be controlled according to generation of a preset touch on the touchpad or touch screen, or according to reception of a preset voice signal through the microphone.

The control unit 600 controls the overall operation of the mobile terminal, and controls signal exchange between the internal components thereof. The control unit 600 controls signal exchange between the input unit 200, the audio processing unit 300, the display unit 100, the storage unit 400, and the detecting module 500.

More particularly, the control unit 600 controls an execution of functions related to applications supported by the mobile terminal. The control unit 600 controls operations for the hiding mode and the locking mode during execution of an application function. The control unit 600 controls activation of the hiding mode and the locking mode for privacy protection according to interaction information provided by the detecting module 500 during execution of a specific application function.

More specifically, the control unit 600 may activate the detecting module 500 in response to execution of a specific application or a user request. The control unit 600 activates the hiding mode according to interaction information provided by the detecting module 500 during application function execution. In the hiding mode, the control unit 600 hides screen data of the application function in a preset manner. For example, to hide current screen data, the control unit 600 may turn off the display unit 100 or invoke a preset screensaver. In other words, when the hiding mode is activated in response to a user interaction, the control unit 600 may turn off the backlight of the display unit 100 while sustaining screen data, or may make a screen transition by placing the application function in the background and displaying screen data of a preset screensaver.

In response to preset user interaction in the hiding mode, the control unit 600 may deactivate the hiding mode. For example, when the detecting module 500 detects user interaction after activation of the hiding mode, the control unit 600 may deactivate the hiding mode. When a preset input signal is generated by the input unit 200 or the display unit 100 after activation of the hiding mode, the control unit 600 may deactivate the hiding mode.

When the hiding mode is deactivated, the control unit 600 recovers the screen data that was hidden for privacy protection. For example, the control unit 600 may turn on the display unit 100 to make the screen data visible, or stop the screensaver and place the application function in the foreground to display the corresponding screen data (i.e., screen transition).

The control unit 600 may measure the elapsed time after activation of the hiding mode. The elapsed time may be measured using a timer (not shown). When user interaction for deactivating the hiding mode is not detected for a preset time, the control unit 600 may activate the locking mode. In the locking mode, use of the mobile terminal may be restricted or execution of the application function may be terminated according to user settings.

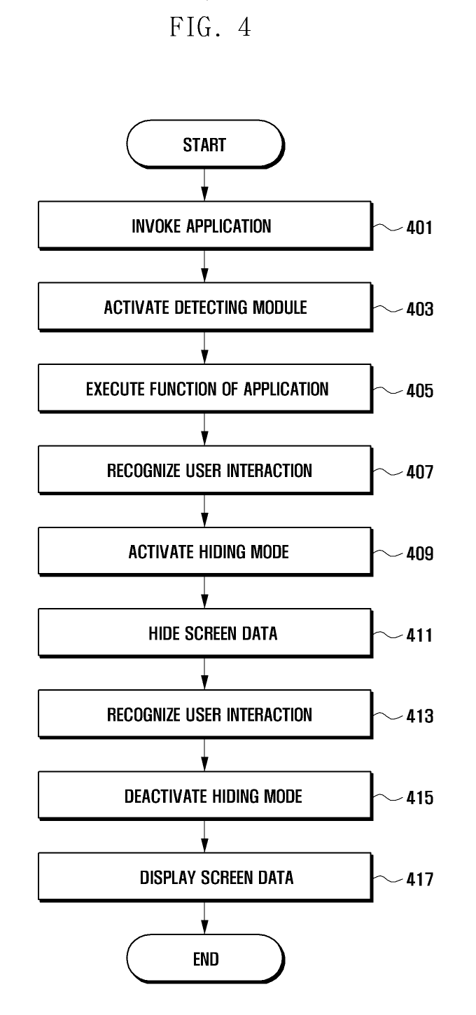

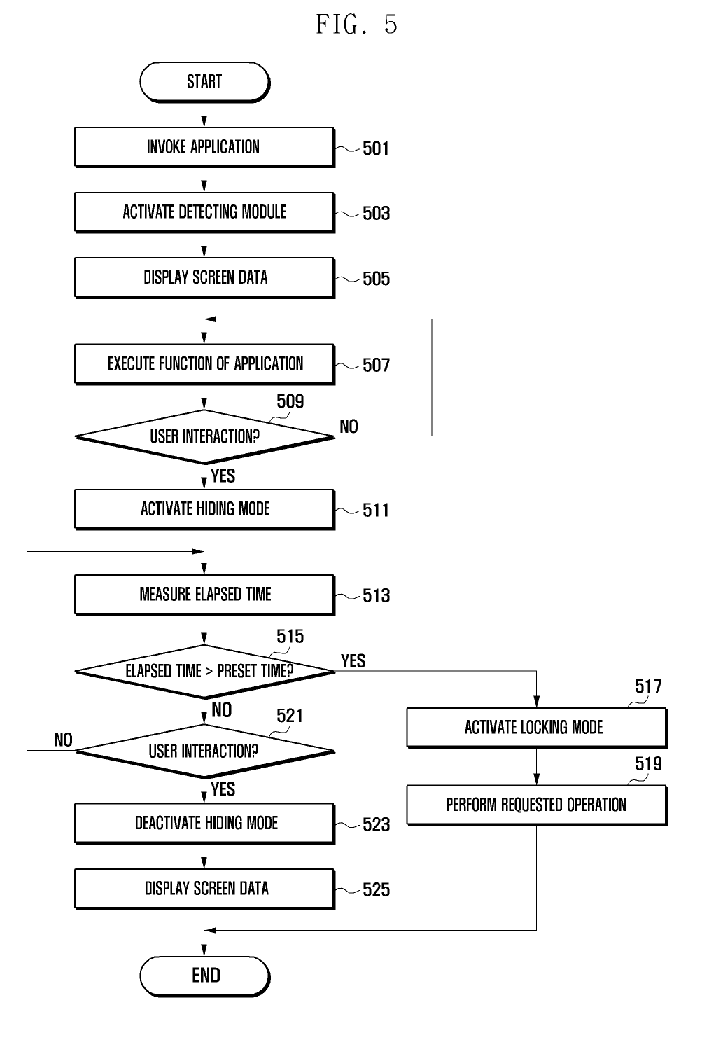

Control operations performed by the control unit 600 for privacy protection are described with reference to the following drawings. That is, as described in FIGS. 4 and 5, the control unit 600 controls the overall operation of the mobile terminal for privacy protection. These control operations may be implemented as software with a specific algorithm.

The configuration of the mobile terminal depicted in FIGS. 1 to 3 is simplified for the purpose of description. However, the mobile terminal is not necessarily limited by such a configuration.

The mobile terminal may further include a baseband module and a radio frequency unit (not shown) to receive a mobile communication service from a mobile communication system through an established channel. Although not shown in FIGS. 1 to 3, according to design, the mobile terminal may further include a Global Positioning System (GPS) receiver to obtain location information, a Bluetooth module for short range communication, a wired or wireless interface unit for data transmission, an Internet communication module for connecting to an Internet Protocol network, and a digital broadcast reception module for receiving and reproducing mobile broadcasts. It should be apparent to those skilled in the art that the mobile terminal may further include a unit comparable to (other than) the above-described units, and one unit may be removed or replaced by another unit.

Hereinabove, a description is given of the mobile terminal of the present invention. A description is given below of a method of privacy protection in connection with FIGS. 4 and 5. However, the method of the present invention is not limited to or by the following description, and various changes and modifications are possible based on the following description.

FIG. 4 is a flowchart of a method for privacy protection in a mobile terminal according to an exemplary embodiment of the present invention.

Referring to FIG. 4, the control unit 600 of the mobile terminal invokes an application in response to a user request in step 401. In step 403, the control unit 600 activates the detecting module 500 according to user settings. The detecting module 500 may be activated manually according to an explicit user selection or activated automatically by application invocation. In manual activation, the detecting module 500 may be activated by the user before or after application invocation. In automatic activation, the detecting module 500 may be activated by invoking any application or by invoking only a preset application according to user settings.

In step 405, the control unit 600 executes a function of the application. For example, when a message application is invoked, the control unit 600 may display screen data related to the User Interface (UI) and execute a message composition function based on the user input through the UI.

In step 407, the control unit 600 recognizes user interaction through the detecting module 500 during execution of the application function. When the detecting module 500 detects user interaction, it sends corresponding interaction information to the control unit 600.

Upon recognition of user interaction, the control unit 600 activates the hiding mode in step 409. In the hiding mode, the control unit 600 hides screen data of the application function according to preset option information in step 411. The option information includes settings for privacy protection operation in the mobile terminal. For example, when the option information indicates a screen transition option for privacy protection, the control unit 600 performs screen transition by replacing the screen data of the application function with screen data of a preset screensaver in the hiding mode. When the option information indicates a screen-off option for privacy protection, the control unit 600 turns off the backlight of the display unit 100 in the hiding mode.

In step 413, the control unit 600 recognizes user interaction through the detecting module 500 in the hiding mode where the screen data of the application function is hidden. When the detecting module 500 detects user interaction in the hiding mode, it sends corresponding interaction information to the control unit 600.

Upon recognition of user interaction in the hiding mode, the control unit 600 deactivates the hiding mode in step 415. After deactivation of the hiding mode, the control unit 600 displays the screen data of the application function according to the option information in step 417. For example, when the screen transition option is used for screen data hiding, the control unit 600 performs screen transition by replacing the screen data of the preset screensaver with screen data of the application function after hiding mode deactivation. When the screen-off option is used for screen data hiding, the control unit 600 recovers the screen data of the application function by turning on the backlight of the display unit 100.

FIG. 5 is a flowchart of a privacy protection method according to an exemplary embodiment of the present invention.

Referring to FIG. 5, the control unit 600 of the mobile terminal invokes an application in response to a user request in step 501. In step 503, the control unit 600 activates the detecting module 500 according to user settings. Here, the detecting module 500 may be activated manually according to user selection before or after application invocation, or be activated automatically along with application invocation.

The control unit 600 displays screen data of the application in step 505, and executes a function of the application in step 507. For example, when a message application is invoked, the control unit 600 may display UI screen data and execute a message composition function based on the user inputs. In an exemplary embodiment of the present invention, the application may be any application supported by the mobile terminal related to, for example, message composition, message reading, moving image playback, digital broadcast reception, text viewing, image viewing, and electronic mail. Hence, the screen data may be dynamic or static according to the corresponding application.

In step 509, the control unit 600 determines whether user interaction is recognized through the detecting module 500 during execution of the application function. If it is determined in step 509 that the detecting module 500 detects user interaction, it sends corresponding interaction information to the control unit 600.

In contrast, if it is determined in step 509 that user interaction is not recognized, the control unit 600 returns to step 507 and continues function execution. Upon determining in step 509 that user interaction is recognized, the control unit 600 activates the hiding mode in step 511, and starts to measure the elapsed time after hiding mode activation in step 513. That is, the control unit 600 hides the screen data of the application function through screen transition or by turning off the backlight, and measures the elapsed time after hiding mode activation.

In the hiding mode, the control unit 600 determines whether the elapsed time exceeds a preset threshold time in step 515. If it is determined in step 515 that the elapsed time exceeds the threshold time, the control unit 600 activates the locking mode in step 517. That is, if the hiding mode is active for longer than the threshold time, the locking mode is enforced. In the locking mode, the use of the mobile terminal may be restricted or the currently executed application may be terminated according to user settings. In the locking mode, the control unit 600 performs an operation according to a user request in step 519. For example, the control unit 600 may deactivate the locking mode or invoke another application in response to a user request.

In contrast, if it is determined in step 515 that the elapsed time does not exceed the threshold time, the control unit 600 then determines whether a user interaction for hiding mode deactivation is recognized in step 521. If it is determined in step 521 that user interaction is not recognized, the control unit 600 returns to step 513 and sustains the hiding mode. In contrast, if it is determined in step 521 that user interaction for hiding mode deactivation is recognized, the control unit 600 deactivates the hiding mode in step 523. After hiding mode deactivation, the control unit 600 displays the screen data of the application function according to the option information in step 525. For example, when the screen transition option is used for screen data hiding, the control unit 600 performs screen transition by replacing the screen data of the preset screensaver with the screen data of the application function. When the screen-off option is used for screen data hiding, the control unit 600 recovers the screen data of the application function by turning on the backlight of the display unit 100.

As apparent from the above description, an exemplary embodiment of the present invention provides a method and an apparatus for privacy protection in a mobile terminal that can effectively hide private information for a short or long period of time based upon simple user interaction during use of the mobile terminal. Hence, user privacy can be effectively protected during use of the mobile terminal. In the hiding mode, the status of the active application can be preserved. Hence, the active application can be resumed and the screen data thereof can be recovered after hiding mode deactivation. As a result, the user may suspend execution of an application for privacy protection and resume the execution of the application through simple interaction without repeating cumbersome actions.

The above-described methods according to exemplary embodiments of the present invention can be implemented in hardware, as software, or a computer code that can be stored in a recording medium such as a Compact Disc (CD) ROM, a RAM, a floppy disk, a hard disk, or a magneto-optical disk or downloaded over a network. The methods described herein can be rendered in such software using a general purpose computer, or a special processor or in programmable or dedicated hardware, such as an Application Specific Integrated Circuit (ASIC) or a Field Programmable Gate Array (FPGA). As would be understood in the art, the computer, the processor, or the programmable hardware may include memory components, such as, a RAM, a ROM, a Flash, and the like. That may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for privacy protection in a mobile terminal, the method comprising:
displaying screen data of an application in execution on a display unit;
recognizing a user interaction to hide the displayed screen data of the application;
hiding the screen data of the application from the display unit upon recognition of the user interaction.

2. The method of claim 1, wherein the hiding of the screen data of the application comprises:
activating a hiding mode in response to the user interaction; and
hiding, in the hiding mode, the screen data according to preset option information specifying a hiding scheme.

3. The method of claim 2, wherein the option information indicates at least one of a screen transition option and a screen-off option as a hiding scheme.

4. The method of claim 3, wherein the hiding of the screen data of the application comprises performing a screen transition after hiding mode activation by placing the application in the background and displaying screen data of a screensaver on the display unit.

5. The method of claim 3, wherein the hiding of the screen data of the application comprises turning off the display unit while sustaining the application after hiding mode activation.

6. The method of claim 3, wherein the screen data of the application includes at least one of dynamic data and static data provided by the mobile terminal and photographic data provided by the user set as screensaver data according to user settings.

7. The method of claim 3, further comprising:
deactivating the hiding mode upon recognition of the user interaction to restore the screen data of the application within a preset threshold time after hiding mode activation; and
displaying the screen data of the application on the display unit upon deactivating the hiding mode.

8. The method of claim 7, wherein deactivating the hiding mode comprises at least one of displaying the screen data of the application after terminating execution of a screensaver and turning on the display unit, according to the option information.

9. The method of claim 3, further comprising activating a locking mode when the user interaction is not recognized within a preset threshold time after hiding mode activation.

10. The method of claim 1, wherein the application may be any application supported by the mobile terminal related to at least one of composing a text message, viewing a text message, composing an electronic mail, viewing an electronic mail, viewing a moving image, viewing a still image, and receiving a digital broadcast.

11. A mobile terminal comprising:
a display unit for displaying screen data of an application being executed, and for being turned off or replacing the screen data of the application with screen data of a screensaver upon activation of a hiding mode;
a storage unit for storing option information that processes the hiding mode and for storing threshold time information that activates a locking mode after the hiding mode activation;
a detecting module for detecting user interaction and for producing corresponding interaction information; and
a control unit for controlling the display unit to hide screen data of the application in response to reception of interaction information from the detecting module during execution of the application.

12. The mobile terminal of claim 11, wherein the detecting module comprises at least one of a proximity sensor, an ambient light sensor, and a camera module.

13. The mobile terminal of claim 12, wherein the control unit activates the hiding mode upon receiving the interaction information, and performs screen data hiding according to the option information.

14. The mobile terminal of claim 13, wherein the control unit hides the screen data by controlling at least one of displaying screen data of the screensaver after placing the executed application in the background and turning off the display unit while sustaining the executed application, according to the option information.

15. The mobile terminal of claim 14, wherein the control unit deactivates the hiding mode when the interaction information is received from the detecting module within a preset threshold time after hiding mode activation, and controls the display unit to display the screen data of the application.

16. The mobile terminal of claim 15, wherein the control unit deactivates the hiding mode by controlling at least one of displaying the screen data of the application after terminating execution of the screensaver and turning on the display unit, according to the option information.

17. The mobile terminal of claim 13, wherein the control unit activates a locking mode when interaction information is not received from the detecting module within a preset threshold time after the hiding mode activation.
